(19) United States
(12) Patent Application Publication
(10) Pub. No.: US 2004/0109546 A1
(43) Pub. Date: Jun. 10, 2004

(54) Method and system for transmitting spectrally bonded signals via telephone cables

(76) Inventor: Ilya M. Fishman, Palo Alto, CA (US)

Correspondence Address: FISHMAN CONSULTING, 558 CAMBRIDGE AVENUE, PALO ALTO, CA, 94306, US

(21) Appl. No.: 10/726,977

(22) Filed: Dec. 3, 2003

Related U.S. Application Data
(60) Provisional application No. 60/431,021, filed on Dec. 5, 2002.

(51) Int. Cl. H04M 11/00; H04M 1/24; H04M 3/08; H04M 3/22

(52) U.S. Cl. 379/93.01; 379/3

(57) ABSTRACT

Method and system are provided for optimization and transmission of digital signals through twisted pairs of telephone cables. Crosstalk reduction is obtained due to cancellation of electromagnetic fields generated by correlated twisted pairs by establishing mutual pair-to-pair coherence at each tone of a transmission spectrum and introducing a requested phase shift between the tones propagating in different pairs.

### FIELD OF THE INVENTION

This invention in general relates to transmission of radio frequency signals (in MHz range) through telephone cables, and in particular, to systems and methods performing transmission of signals through twisted pair wires for broadband services.

### BACKGROUND OF THE INVENTION

Currently deployed systems and methods developed for transmission of signals through copper twisted pairs were initially dedicated for low-speed (64 KBits/sec) telephone services. To provide telephone service, the US territory is divided into a plurality of service areas known as Customer Service Areas (CSAs) of specific dimensions. For example, with 24-gauge twisted pair wiring, maximum distance of 4 miles between a Central Office (CO) and customer premises is typical for the U.S. This distance limitation is defined by signal attenuation and channel-to-channel crosstalk in twisted pair cables.

Before Internet development, an idea of transmitting video over twisted pairs was extensively explored. Recently, twisted pair telephone cables were utilized for Internet connections with the bit rate of the order of 1 MBits/sec and faster. DSL technology was developed to meet technical requirements of ADSL, VDSL and other applications. DSL modems became conventional devices for Internet connection used by businesses and households in the USA and other countries. However technical specifications of existing copper networks originally formulated for narrow band telephone connections create technical problems and constrains for Internet applications.

Twisted pair cables are characterized by frequency dependent power loss, phase delay and interference noise, especially pronounced at high frequencies. FIG. 1 shows typical power loss (attenuation) and crosstalk accumulation as a function of frequency [J. A. C. Bingham, “ADSL, VDSL, and Multicarrier Modulation”, John Wiley and Sons, Inc., 2000]. Even at low frequencies of several KHz, power loss and phase delay are pronounced, and above 600 KHz signal power level becomes lower than crosstalk making signal transmission difficult. To take care of signal power loss and distortions, Discrete Multi-Tone (DMT) transmission format was developed initially for voice service (for example, U.S. Pat. No. 4,731,816), and later applied to DSL transmission (for example, U.S. Pat. No. 5,673,290). In DMT format, spectrum is sliced in many narrow slots, with attenuation and dispersion almost constant within the slot. In each slot, a carrier frequency source is provided. The presently accepted and standardized Asymmetric Digital Subscriber Line transmits data using DMT scheme with 256 tones (frequency slots) each 4.3125 kHz wide, full frequency range being 1.104 MHz (FIG. 1). Bit stream of rate b is converted into several parallel symbols which are applied to modulate a discrete set of tones, then Fourier-transformed into time-domain samples, passed through P/S converter and sent through the transmission line as a time-dependent waveform. Quadrature Amplitude Modulation (QAM) is applied to the carrier wave in each frequency slot; both number of bits and transmitted power may be optimized depending on carrier wave attenuation and phase shift in a given slot. On the receiving end, signal amplitude and phase in each frequency slot is individually equalized, and other procedures are applied in the inverse order.

The improvements achieved by DMT systems are limited, and high frequency services provided in the field commonly does not cover more than 50% of CSA. In all practical applications, bandwidth was “traded” for distance. Today, ADSL service (1.5 MBits/sec) may be delivered over 12, 000 ft, which is substantially less than maximum distance across CSA. Limitations of copper cables are even more pronounced for bit rates higher than 1.5 MBits/sec. A wide variety of business applications require transmission rates of 25.6 MBits/sec or 51.84 MBits/sec. These kind of signals may be transmitted through twisted pairs only at very short distances (less than 1,000 ft at 100 Mbits/sec).

Several attempts have been made to improve broadband performance to increase bit rate and transmission distances. In one approach, called inverse multiplexing, the high-bit rate signal is demultiplexed into lower bit rate traffic streams, and low bit rate traffic streams are transmitted over several independent twisted pairs. Thus, transmission of relatively high bit rate traffic (up to 100 Mbit/s) may be achieved using 24 to 48 pairs. Details of this transmission technology are described, for example, in U.S. Pat. No. 6,198,749 “System for inverse multiplexing analog channels.” Inverse multiplexing technology upgrades copper network to higher bit rate without upgrading individual pair performance. Though the cost associated with the inverse multiplexing technology may be lower than fiber deployment cost, the cost of multiple transmitter-receiver pairs plus mux-demux circuits is substantial.

Another approach to upgrade twisted pair performance is called vectoring and offers algorithm to compensate for signal distortion caused by strong pair-to-pair crossialk. The twisted pair is an open circuit, and interaction of the pair's electromagnetic field with other circuits is the major source of power attenuation and crosstalk. For both mechanisms of signal degradation, the adjacent pairs introduce major power loss and crosstalk. Vectoring is part of general Dynamic Spectral Management (DSM) approach to manage several DMT channels (pairs) together as a transmission unit. In a single DMT system, bits from different tones with low signal-to-noise (S/N) ratio may be transferred to other tones with high S/N. DSM applies the same idea to the unit consisting of several channels (pairs) strongly interacting with each other. The aggregate of l transmission channels may be presented by a matrix equation [A. Paulraj, V. Roychowdhury and C. Schaper (Ed.), Communication, Computation, Control, and Signal Processing (a tribute to Thomas Kailath), Kluwer: Boston, 1997]:

Y(ƒ)=H(ƒ)·X(ƒ)+N(ƒ)

where H (ƒ) is a lxl matrix of channel transfer functions, X(ƒ) is a “vector” of l inputs, N(ƒ) is noise (including crosstalk), and Y(ƒ) is a vector of l channel outputs. Off-diagonal matrix elements of H represent mutual crosstalk between each couple of interacting pairs. Ideal performance of Dynamic Spectral Manager is described by the following equation:

Z=WY=BX+E

where matrix W causes the channel output Z=WY to appear free of crosstalk, with the error matrix E being “white” noise. Any practical approach to implement the last equation implies adding corrective components to each pair output to obtain the crosstalk free signal at the receiver input. No commercial system based on DSM is available at the time of this writing but numerous examples were presented in the literature. Calculations demonstrate that vectoring may improve individual pair performance by several times. However vectoring does not decrease power loss, and in homogeneous networks the improvement is marginal.

In the present invention, system and method is provided to improve individual pair transmission by decreasing both power loss and crosstalk, using mutual cancellation of fields generated by several correlated pairs.

### SUMMARY OF THE INVENTION

The present invention provides method of Spectral Bonding (SB) and system thereto improving transmission through individual twisted pair by selecting an aggregate of correlated (strongly interacting) pairs and managing transmission through the aggregated pairs tone-by-tone, minimizing the electromagnetic field outside the aggregate by cancellation of electromagnetic fields generated by correlated pairs. As a result of this cancellation, power dissipated by each pair and the crosstalk between the aggregate of correlated pairs and the rest of the cable may be reduced by almost two orders of magnitude. In cables having pairs of different twisting periods (pitches), and other types of twisting irregularities, the method of the present invention provides minimization of pair-to-pair crosstalk by mutual cancellation of electromagnetic fields generated by correlated pairs. The level of crosstalk reduction is about two orders of magnitude. The method of the present invention, unlike current treatment of copper pairs as independent entities generating mutually incoherent fields, directly explores interference of mutually coherent electromagnetic fields of correlated pairs. The aggregate of correlated pairs responds to each tone as a diffraction grating responds to a harmonic optical or microwave field.

To establish coherence among correlated pairs, respective signals have to be mutually synchronized, and amplitudes and phases of electromagnetic fields generated by different pairs have to be equalized on tone-by-tone basis. Within the aggregate of correlated pairs, relative amplitudes and phases of each tone are chosen to minimize the loss of electromagnetic energy and/or reduce the pair-to-pair crosstalk.

To implement the steps of the SB method, the system of the present invention comprises DSLAMs with re-timing and equalizing circuits, common clock and Spectral Bonding Unit (SBU) establishing mutual pair-to-pair coherence at each tone and introducing appropriate phase shifts between the tones propagating in different pairs.

### BRIEF DESCRIPTION OF THE DRAWINGS

The foregoing aspects and advantages of the present invention will become better understood upon reading the following detailed description and upon reference to the drawings where:

FIG. 1 is a typical graph for twisted pair attenuation and crosstalk according to the prior art.

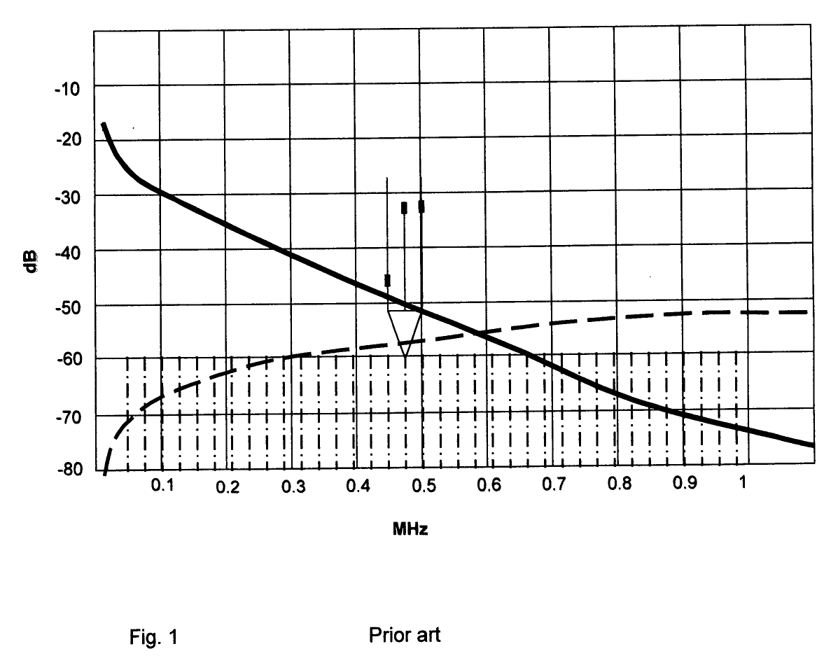

FIG. 2 is a typical architecture of copper twisted pair network between the CO 1 and customer premises 2; copper pairs are well correlated through the shared cable path L; the length of cable sections to each individual customer is short compared to L, and usually does not exceed several hundred feet.

FIG. 3 is an illustration of crosstalk of one copper pair with a 6-pair aggregate described by Eq. (5) with equal partial amplitudes and regular phase differences:

f₁(t,φ)=sin(10t)(cos 0.2φ+cos 0.4φ+cos 0.6φ+cos 0.8φ+cos φ+cos 1.2φ)+cos(10t)(sin 0.2φ+sin 0.4φ+sin 0.6φ+sin 0.8φ+sin φ+sin 1.2φ)

The diagram of FIG. 3 is a phase pattern of a conventional 6-groove diffraction grating with phase period Δφ=10π.

FIG. 4 is an illustration of crosstalk of one copper pair with a 6-pair aggregate described by Eq. (5) with non-equal partial amplitudes and random phase differences:

f₂(t,φ)=sin(10t)[0.5 cos(0.21φ)+1.3 cos(0.41φ)+cos(0.61φ)+0.8 cos(0.81φ)+cos φ+1.2 cos(1.2φ)]+cos(10t)[0.5 sin(0.21φ)+1.3 sin(0.41φ)+sin(0.61φ)+0.8 sin(0.81φ)+sin φ+1.2 sin(1.2φ)]

The diagram of FIG. 4 is a phase pattern of a random 6-groove diffraction grating; it has no phase period but shows clear constructive and destructive interference zones (one of the destructive interference zones is indicated by the arrow).

FIG. 5 is a block diagram of a DMT-based DSLAM consisting of transmitter unit A and receiver unit B.

FIG. 6 is a block diagram of the line card of the present invention

### DETAILED DESCRIPTION OF THE INVENTION

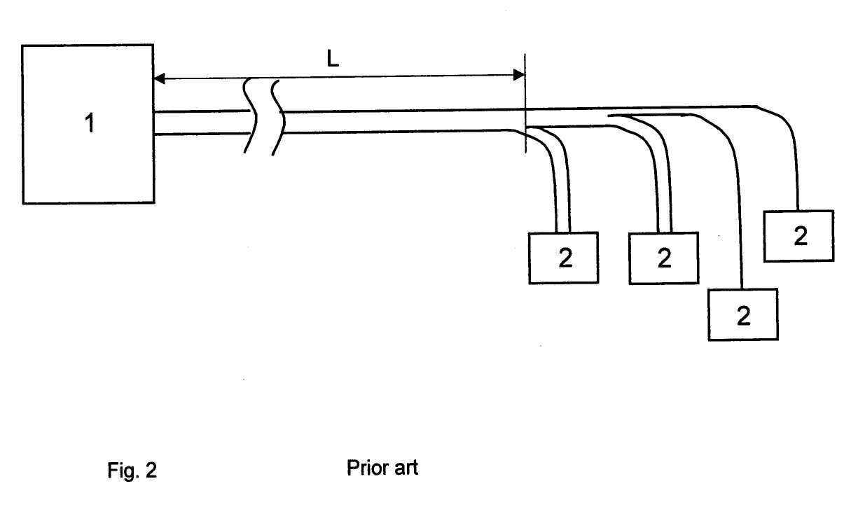

In a typical “tree” network architecture, tree roots are located at CO and branches reach the customer premises. It is expected that the group of geographically co-located customers is served with the aggregate of pairs physically correlated along almost entire cable length L except for last several hundred feet (FIG. 2). For this network architecture, SB approach is developed to expand transmission distance (or bandwidth) per individual pair by reducing power loss per pair and/or crosstalk between the correlated pairs. SB establishes coherence between the same frequency harmonics propagating in correlated pairs, and adjusts phases for destructive interference, or mutual cancellation of pair fields. Exact SB implementation depends on cable design. For the cable composed of pairs having exactly same twist period, mutual field cancellation may be maintained all along the cable length providing reduction of power loss through the cable length. For the cable composed of pairs with different pitches, cancellation of pair fields may be achieved at the customer premises providing reduction of crosstalk. For any cable design, aggregating pairs together and transmitting mutually coherent signals through them allows for significant bandwidth expansion or distance increase per each pair-compared to the case of independent (incoherent) pairs. Interference of crosstalk components in spectrally bonded correlated pairs is equivalent to diffraction of coherent optical field by diffraction grating.

In conventional DMT systems, adjacent pairs are connected to DSL Access Multiplexers (DSLAMs) carrying uncorrelated traffic. Both amplitudes and phases of respective waveforms are uncorrelated. To calculate the rate of power loss from several pairs, the losses from each pair (proportional to square of the pair field) are summed together. Each of these waveforms is a sum of modulated DMT components. According to the subject invention, mutual phase correlations have to be established between the same frequency components in all pairs to provide interference between the pair fields. The essence of SB is adjusting (equalizing) amplitudes and phases for each tone separately through the spectrum shared by signals in all correlated pairs. This procedure is possible in linear systems only.

In the cable section, the field generated by several pairs may be presented as a sum of fields generated by individual pairs; each pair may be characterized by its magnetic dipole moment pᵢ=aIᵢ, where Iᵢ is current through the pair, and a—distance between the pair wires. If the geometrical sum of these moments \overline{d}=ΣIᵢ\overline{p}ᵢ is not zero, potential

$$ϕ ∼ \frac{d}{{r}^{2}}$$

fells of as square of distance r from the geometrical center of the wire assembly (consideration of electrical dipole moments is similar). Power loss from an aggregate of several pairs is defined by a square of field potential. If the dipole moment is close to zero, next components in the expansion of the potential have to be taken into account:

φ=φ⁽¹⁾+φ⁽²⁾+ . . . ,

where φ⁽¹⁾ is dipole, and φ⁽²⁾-quadruple moment of the electrical current distribution. Quadruple moment of pair assembly never equals zero, but its absolute value is about an order of magnitude smaller than the dipole moment. Power loss is proportional to φ², and if the value of dipole moment is reduced below the value of quadruple moment, power loss is reduced by two orders of magnitude.

The number of pairs in telephone cables varies from 200 (leaving CO) to (2-4) pairs at customer premises. At each cable section, relative orientation of pairs is defined by special color code; each couple of pairs found next to each other in certain cable section, will stay next to each other in remote sections. In general, twisting period may be slightly different for adjacent pairs to reduce pair-to-pair electrical interaction. Depending on stability of cable manufacturing process and cable installation and management practice, long-distance periodicity may or may not be provided.

### Cable Composed of Pairs with Exactly Same Twist Period

For this type of cable, the SB of transmitted signals reduces power loss. Phase relations between the same spectral components remain unchanged along the copper plant. With more than two pairs aggregated, dipole moment may be cancelled exactly. As an example, to achieve φ⁽¹⁾=0 in a 4-pair aggregate with dipole moments \overline{a}, \overline{b}, \overline{c}, \overline{d} tilted to horizontal axis by angles α, β, γ and δ respectively, a system of two linear equations has to be satisfied:

a cos α+b cos β+c cos γ+d cos δ=0

a sin α+b sin β+c sin γ+d sin δ=0

Eq. (1) has a solution for any set of α, β, γ and δ.

When the tones are amplitude modulated more pairs have to be aggregated to eliminate the dipole moment. Consider QAM tone

uᵢ=sin ωt+cos ωt+aᵢ cos(ω+Ω)t+bᵢ sin(ω+Ω)t+aᵢ cos(ω−Ω)t−bᵢ sin(ω−Ω)t (2)

where i=1 . . . N, N is the number of aggregated pairs. To achieve φ⁽¹⁾=0, the system of linear equations has to be satisfied:

α₁₁x₁+a₁₂x₂+α₁₃x₃+ . . . +α_{1N}x_{N}=0

α₂₁x₁+α₂₂x₂+α₂₃x₃+ . . . +α_{2N}x_{N}=0

α₃₁x₁+a₃₂x₂+α₃₃x₃+ . . . +α_{3N}x_{N}=0

α₄₁x₁+a₄₂x₂+α₄₃x₃+ . . . +α_{4N}x_{N}=0

α₅₁x₁+a₅₂x₂+α₅₃x₃+ . . . +α_{5N}x_{N}=0

α₆₁x₁+a₆₂x₂+α₆₃x₃+ . . . +α_{6N}x_{N}=0

where α₁ᵢ=cos(\overline{d}ᵢ,x), α₂ᵢ=sin(\overline{d}ᵢ,x) are orthogonal projections of unmodulated dipole moment components, α₃ᵢ=aᵢ cos(\overline{d}ᵢ,x), α₄ᵢ=aᵢ sin(\overline{d}ᵢ,x),α₅ᵢ=bᵢ cos(\overline{d}ᵢ,x), α₆ᵢ=bᵢ sin(\overline{d}ᵢ,x) are orthogonal projections of the quadrature modulated components from Eq.(2), and xᵢ are equalization parameters e.g. constants defining how the respective pair tone has to be “stretched” to nullify the dipole moment. Without losing generality, one of the unknowns may be put to unity, x₁=1. After that, the system of equations (3) has a nontrivial solution if the number of aggregated pairs N=7 or N>7. Eq. (3) presents the algorithm of defining ratios between signal amplitudes and phases in correlated pairs.

This ratio has to be defined for each tone and for each time domain data sample. On the receiving end, signal carried by each tone has to be normalized to the amplitude of unmodulated component. Thus, equalization procedure on the receiving end is practically the same as for uncorrelated pairs.

The procedure described above provides reduced rate of power loss by nullifying the dipole moment outside of the pair aggregate but neglects the pair crosstalk among the aggregated pairs; the crosstalk power is enhanced to the same extend as the signal power. To reduce crosstalk one has to conduct vectoring (add inverse phase crosstalk components after the equalization step); vectoring is performed after equalization because equalization needs relatively large changes in each tone amplitudes and phases. The procedure of Eq. (3) has to be repeated again for crosstalk corrected fields; the number of iterations has to be defined in the process of system initialization.

Reduction of power loss rate to theoretical limit is possible only if the pairs are identical, and angles α, β, γ and δ does not change along the cable. For other types of cable, the dipole moment may not be reduced to zero, and SB implies destructive interference between the same spectral tones in correlated pairs to minimize the power loss and/or crosstalk.

### Cable Composed of Pairs with Different Twist Periods

If the cable is composed of pairs having different pitches, relative angles between the pairs change along the cable length, and constructive or destructive interference occurs in different cable sections. If the pitch difference is about several percent, the cable length corresponding to full cycle of constructive-destructive interference is ˜10² pitches, or several meters of the cable length. In this type of cable, systematic reduction of power loss is impossible but crosstalk may be reduced significantly.

For each tone, the crosstalk induced in the m-th pair by (m−1) waves propagating in other pairs is

fₘ(t)=a₁ sin(ωt−k₁z)+a₂ sin(ωt−k₂z)+ . . . +aₘ₋₁ sin(ωt−kₘ₋₁z) (4)

where wave vectors

$${k}_{i} = \frac{ω}{{V}_{i}} ,$$

Vᵢ-phase velocity in i-th pair. Equations (4) may be presented as

fₘ(t,φ))=sin(ωt−<k>z)(a₁ cos φ₁+a₂ cos φ₂+ . . . +aₘ₋₁ cos φₘ₋₁)+cos(ωt−<k>z)(a₁ sin φ₁+a₂ sin φ₂+ . . . +aₘ₋₁ sin φₘ₋₁) (5)

where

$${ϕ}_{i} = \frac{ω L Δ {V}_{i}}{⟨ V ⟩}$$

are phase variations caused by difference of phase velocities in different pairs, L-common length of the pair aggregate, <V>-average propagation velocity, ΔVᵢ-velocity variation in i-th pair. Propagation of each tone through the aggregate of (m−1) twisted pairs is equivalent to interaction of monochromatic wave with a diffraction grating having (m−1) grooves, each groove introducing phase shift φᵢ. Though performance of regular gratings is different from gratings with random phase shifts between the grooves, both constructive and destructive interference is clearly observed.

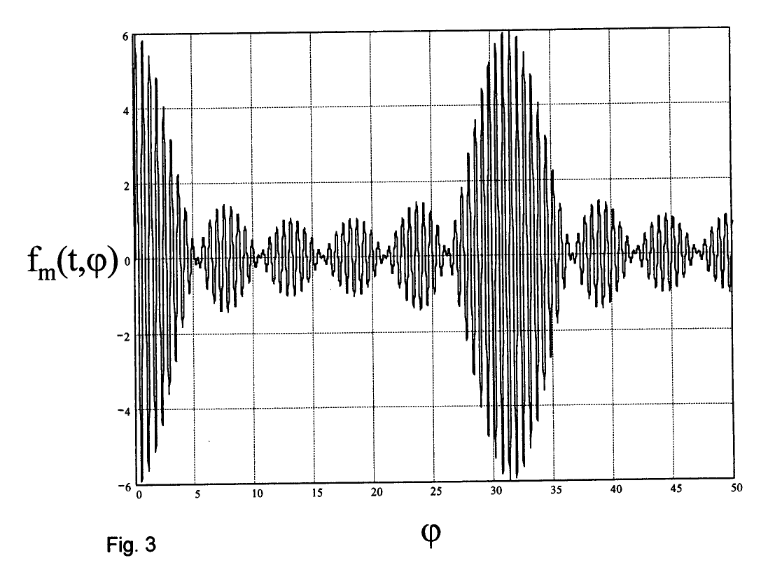

FIG. 3 illustrates performance of a 6-groove regular grating described by Eq. (5), with equal partial amplitudes and commensurate phase shifts. The grating shows distinctive constructing interference at certain values of phase (10π, 20π, . . . ); maximum constructive interference amplitude is 6, and 5 zero amplitude destructive interference zones are observed.

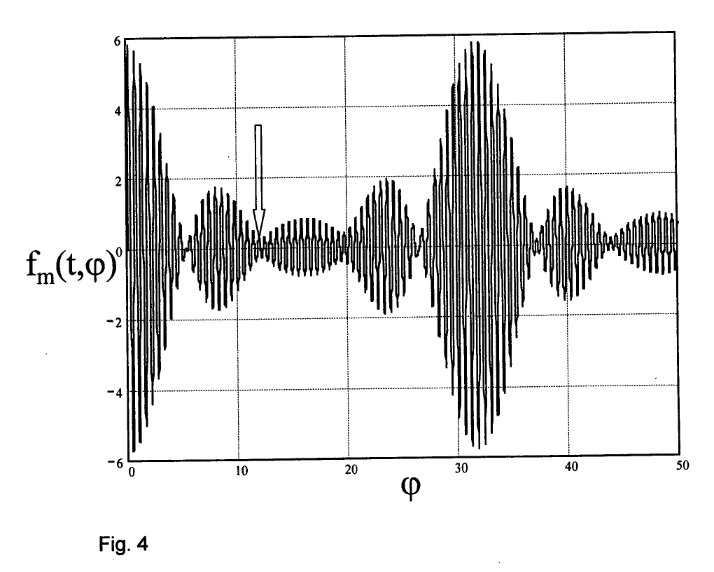

FIG. 4 demonstrates how the grating performance changes when partial amplitudes and phase differences become random. With random amplitudes and phases, constructive and destructive interference zones are still very distinctive, though the interference pattern is complicated and not periodic. For example, the interference pattern of FIG. 4 shows only 4 zones of destructive interference, with non-zero minimum amplitude. However, the grating efficiency remains very high, especially compared to the case of non-correlated waves. In the example of FIG. 4, the sum of intensities of the partial waves from all grooves (if they are uncorrelated) is about 6; the minimum intensity of correlated waves in the point indicated by the arrow in FIG. 4 is (0.3)²˜0.1, and the crosstalk reduction is about 60, which is close to theoretical limit of crosstalk defined by aggregate quadruple moment. Numerical calculations show that for m>3, a specific set of phases φᵢ could be found corresponding to fₘ(t)=0 or fₘ(t)<<1. To determine respective set of phases φᵢ for each specific cable in the field, frequency scanning or equivalent procedure of phase variation has to be conducted to determine the interference pattern of the type shown in FIG. 4. Phases φᵢ are, in general, functions of the modulation carried by each tone. Amplitude and phase of each tone modulation is defined by the parameters aᵢ of Eq. (5), and each data symbol carries its unique set of parameters aᵢ. In the process of signal transmission, this set is retrieved from system memory and may be used for crosstalk equalization.

Two cable designs considered above represent limiting cases of fully “coherent” cable with equal pitches and fixed angles between pairs, and a totally “incoherent” cable with pairs of random and non-commensurate pitches. Other types of cables may be analyzed similar to the above cases. For example, if the cable is composed of pairs having equal pitches but pairs randomly lose exact orientation relative to each other, the approach of Eq. 1-3 is not applicable but the consideration of constructive and destructive interference of FIG. 4 is valid. For this type of cable, destructive and constructive interference zones occur along the cable length, and performance improvement relates to crosstalk reduction. For another type of cable composed of exactly periodic pairs with different but commensurate pitches, consideration of FIG. 3 (regular grating) is applicable.

If correlated pairs carry different services with different spectral content (for example, ADSL and VDSL) than only the spectral part shared by all pairs is relevant for Spectral Bonding. Respectively, only the tones belonging to shared spectrum have to be synchronized and equalized. The procedure described above for one tone, has to be applied to all DMT frequencies, and each tone is equalized independently.

While in the conventional DMT technology equalization is applied at the receiving end to compensate for frequency dependent power loss and phase shift at each tone frequency, SB equalization procedure is applied to mutually coherent tones at the transmitting end.

SB methodology was disclosed in conjunction with DMT systems. However, similar consideration of mutual coherence of signals in adjacent pairs is applicable to any other linear system with or without dispersion. Those skilled in the art will be able to apply the teaching of this invention to QAM format or other formats where linear expansion of the signal into Fourier series or other equivalent expansions are possible.

### System for Transmitting SB Signals Via Telephone Cables

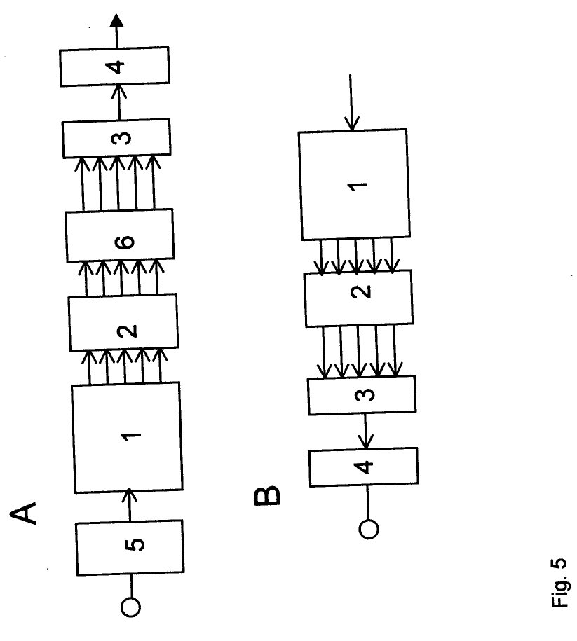

FIG. 5 shows block-diagram of the DSLAM of the present invention. DSLAM consists of transmitter unit A and receiver unit B. Transmitter unit A comprises circuits of buffer/encoder 1, Inverse Fast Fourier Transform (IFFT) block 2, parallel/serial converter (P/S) 3, digital-to-analog converter (DAC) 4, re-timing block 5 and equalizer 6. Receiver unit B comprises conventional circuits of buffer/encoder 1, IFFT block 2, parallel/serial converter 3, and digital-to-analog converter 4, connected in inverse order.

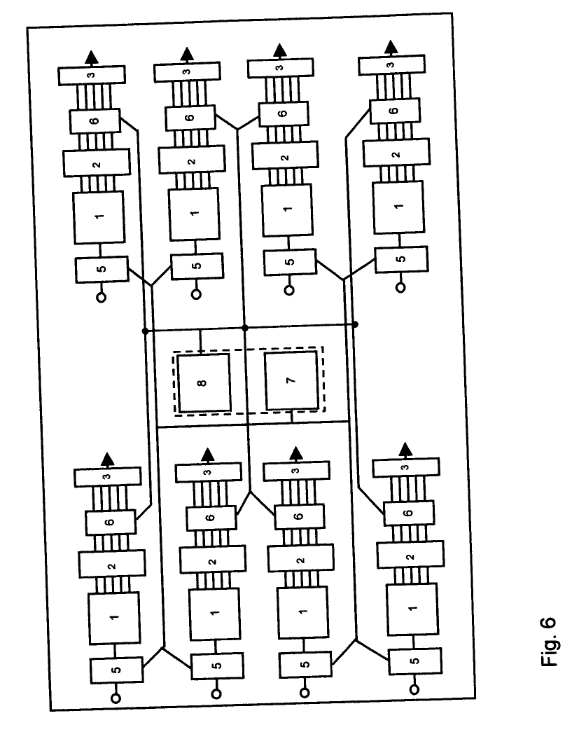

FIG. 6 shows block-diagram of a system line card comprising eight DSLAMs. Only DSLAM transmitter units and their connections are shown in FIG. 6. The number of DSLAMs on the line card defines maximum number of correlated pairs if line cards do not communicate to each other. If the required number of correlated pairs exceeds the number of DSLAMs on one card, communication between line cards on the shelf may be established. All re-timing circuits 5 of all DSLAMs are connected to the Clock circuit 7, and all equalizers 6 are connected to Spectral Bonding Unit (SBU) 8. Each line card comprises one Clock circuit and one SBU.

Independent bit streams entering each DSLAM transmitter unit are mutually synchronized by re-timing circuits 5. Each bit stream is transformed into parallel amplitude-modulated (or QAM) symbols by buffer/encoder circuits 1, which are further transformed into parallel set of time-domain samples by IFFT block 2. Amplitudes and phases of each modulating components of each tone of time domain sample are mutually equalized to provide proper interference among same frequency fields by respective equalizers 6. Equalized time domain samples are converted from parallel to a serial stream by P/S converter 3, further converted from digital into analog form by DAC 4 and transmitted into respective twisted pair. On the receiving end, the procedures are performed conventional for uncorrelated channels unless transmission is symmetric.

SBU collects output time-domain sample information from all IFFT blocks and conducts equalization according to the algorithm specific for each correlated pairs aggregate. This algorithm is established in the process of system initiation, and is stored in SBU memory.

SBU comprises equalizer block and initiation block. Equalizer block has two-way communication with equalizers 5 receiving information on each tone modulation in each time domain sample, comparing modulation data at each tone for all pairs, and returning equalization data back to equalizers 5 in accordance with the equalization algorithm. Initiation block characterizes the pair aggregate and establishes the equalization algorithm. The initiation procedure is automatic, no truck roll or other human intervention is needed. First step of the initiation process is cable characterization: frequency scan of each pair crosstalk induced by same frequency tones in other pairs of the aggregate. Through the scanning procedure, the cable type is defined. If the cable is composed of exactly same pitch pairs, no frequency dependence is observed, and equalization of the type described by Eq. 3 (reduced power loss) may be implemented. If the cable is composed of pairs with different pitches, the frequency scan defines zeroes of the functions fₘ(t) defined by Eq. 4, and the sets of phase differences between the correlated pairs.

General principles of Method and System of this invention are applicable to both asymmetric and symmetric transmission. In case of symmetric transmission communication has to be established between the modems belonging to several users and deployed at different locations. Local wireless connection may be used for this purpose.

The general principles described in this invention, such as selection of at least a couple of adjacent cooper pairs forming an aggregate for transmitting digital signals therethrough, synchronization of transmitted digital signals with a single clock source for obtaining waveforms propagating in each pair and having mutually synchronized same frequency harmonic components, and providing destructive interference between these harmonic components for each component separately for increasing signal to noise ratio for each pair are applicable, with modifications known to those skilled in the art, to many different possible configurations of telephone cables and their assemblies.

What is claimed is:

1. A method of transmitting signals via telephone cables comprising the steps of:
selecting an aggregate of adjacent twisted pairs within the telephone cable for optimization of signal transmission;
transmitting mutually coherent signals via said selected twisted pairs;
measuring electromagnetic fields generated by mutual interaction between said selected twisted pairs at a receiving end of any of said selected twisted pair; and
reducing crosstalk between said selected twisted pairs by transmitting of said mutually coherent signals having amplitudes and phases corresponding to the destructive interference.

2. The method of transmitting signals of claim 1, wherein the step of measuring electromagnetic fields further comprising the steps of:
measuring amplitudes and phases of interfering electromagnetic fields; and
establishing constructive and destructive interference between said selected twisted pairs.

3. The method of transmitting signals of claim 2, further comprising the step of cable characterization by measuring crosstalk of each said selected twisted pair induced by the same frequency tones in other pairs of said aggregate.

4. The method of transmitting signals of claim 3, wherein said twisted pairs have regular twist periods.

5. The method of transmitting signals of claim 4, further comprising the step of establishing the respective amplitudes and phases of interfering electromagnetic fields to provide destructive interference.

6. The method of transmitting signals of claim 3, wherein said twisted pairs have irregular twist periods.

7. The method of transmitting signals of claim 6, further comprising the step of establishing the respective amplitudes and phases of interfering electromagnetic fields to provide destructive interference.

8. A system for transmitting signals via telephone cables having twisted pairs comprising:
a plurality of transmission units for transmitting respective digital signals via adjacent twisted pairs of the telephone cables, each transmission unit comprising
an encoder for re-coding the digital signal into DSL format,
IFFT block for obtaining a set of parallel samples of different frequencies, and
equalizer for providing interference between electromagnetic fields of said adjacent
twisted pairs; and
spectral boding unit comprising an initiation block for characterization of said twisted pairs and establishing an equalization algorithm, and an equalization block for providing feedback to said equalizers according to the equalization algorithm.

9. The system for transmitting signals of claim 8, further comprising a re-timing block for establishing timing relations between transmission units of said plurality, said re-timing block is connected to each said equalizer and to said spectral bonding unit.

10. The system for transmitting signals of claim 9, wherein said equalization block has two- way communication with each said equalizer for receiving information on each tone modulation in each said set of samples and returning equalization data back to said equalizer.

11. The system for transmitting signals of claim 10, further comprising a plurality of receiving units corresponding to respective plurality of said transmission units for receiving analog signals with cancelled crosstalk that are converted to digital signals of optimized signal transmission.
